(19) United States
(12) Patent Application Publication
(10) Pub. No.: US 2008/0088146 A1
(43) Pub. Date: Apr. 17, 2008

(54) Mobile tent trailer

(76) Inventor: David Ruben Newman, Royal Oak, MI (US)

Correspondence Address: HARNESS, DICKEY & PIERCE, P.L.C., P.O. BOX 828, BLOOMFIELD HILLS, MI, 48303, US

(21) Appl. No.: 11/581,038

(22) Filed: Oct. 13, 2006

(51) Int. Cl. B60P 3/34

(52) U.S. Cl. 296/26.15

(57) ABSTRACT

A mobile tent trailer includes a frame and wheels to allow the trailer to be pulled along a road surface. The frame can have a first floor surface. Side walls can be coupled to the frame and can be moved between a stored position facilitating movement of the trailer along the roadway and an open position wherein the side walls form a second floor surface. A handrail can be secured to the side walls and can move with the side walls between the stored and open positions. The first floor surface can align with the second floor surface to form an elevated platform upon which people may engage in activities when the side walls are in the open position.

### FIELD

The present teachings relate to trailers and more particularly to mobile trailers that can be moved along the roadway and provide an elevated platform at a desired location.

### BACKGROUND AND SUMMARY

The statements in this section merely provide background information related to the present teachings and may not constitute prior art.

Mobile trailers can be used to provide desired facilities at remote locations. Mobile trailers can typically be towed along the roadways. To be towed along the roadways, the mobile trailers must meet certain dimensional requirements. These dimensional requirements can limit the size or usefulness of the mobile trailers. To overcome roadway dimensional limitations, mobile trailers can be configured to transform between a closed or stored state wherein the dimensions allow for the movement of the mobile trailer on the roadways and an open or extended state wherein the mobile trailer is expanded to provide the intended functionality at the site. The transitioning of the mobile trailer from the stored position to the expanded position can be time consuming and can involve many steps. Thus, it would be advantageous if the transition from the stored position to the expanded position is facilitated.

During the transition from the stored position to the expanded position, multiple components, pieces, or accessories may be required to be assembled and/or attached to the mobile trailer. For example, when a mobile trailer provides an elevated platform, handrails and/or stairs may be required to be attached to the mobile trailer to facilitate access to the platform and to guard the edges of the platform. Such assembly can be time consuming and tedious. Additionally, the requirements for assembling and attaching components can result in a number of parts or components which can be subject to damage and/or loss. The loss of such components can possibly render the mobile trailer ineffective for its intended purpose. Thus, it would be advantageous to reduce the number of parts that need to be assembled and/or attached to the mobile trailer. Furthermore, it would be advantageous if the mobile trailer came with a variety of features or components already attached thereto such that the assembly and setup of the mobile trailer is facilitated.

An expandable mobile tent trailer according to the present teachings can include a frame and at least two wheels coupled to the frame and operable to allow the mobile tent trailer to be pulled along a roadway. The frame can include a first floor surface. At least one side wall can be moveably coupled to the frame and can be moved relative to the frame between a first position wherein the mobile tent trailer can be hauled along the roadway and a second position wherein the at least one side wall forms a second floor surface. A handrail can advantageously be secured to the at least one side wall and move with at least wall between the first and second positions. The first and second floor surfaces can form a platform upon which people may engage in activities when the at least one side wall is in the second position. The handrail can include a first stationary portion that is fixedly secured to the at least one side wall. The handrail can include a second portion that is moveably coupled to the first portion and can be moved between a retracted position corresponding to a first height of the handrail and an extended position corresponding to a second height of the handrail greater than the first height.

In another aspect according to the present teachings, an expandable mobile tent trailer can include at least one telescopic handrail having a first stationary portion operable to be attached to the at least one side wall. The at least one handrail can have a second portion telescopically coupled to the first portion. Second portion can be telescopically moveable between a retracted position corresponding to a first height of the at least one handrail and an extended position corresponding to a second height of the at least one handrail greater than the first height.

The expandable mobile tent trailer according to the present teachings advantageously provides a compact structure when in the stored position and can be pulled along a roadway. The transitioning of the expandable mobile tent trailer from the stored position to the open position is advantageously facilitated by the inclusion of a variety of components or assemblies being fixedly coupled to the mobile tent trailer. The handrails can be advantageously moved between a compact retracted state providing a first height and an extended height to thereby allow the handrail to be of varying heights. The fixing of the handrail to the moveable side wall advantageously facilitates the assembly and setup of the mobile tent trailer. The handrails are advantageously in place when the side wall is moved into its open position thereby reducing the assembly steps. Moreover, the movement of the side wall between the stored position and the open position facilitates the forming of a platform on which people can engage in activities when the side wall is in its open position.

Further areas of applicability will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is a perspective view of a mobile tent trailer according to the present teachings in a closed position;

FIG. 2 is a perspective view of the mobile tent trailer of FIG. 1 in an open position with four side shields;

FIG. 3 is a perspective view of the mobile tent trailer of FIG. 1 in an open position with two side shields;

FIG. 4 is a side view of the mobile tent trailer of FIG. 1 with the cover removed;

FIG. 5 is a rear end view of the mobile tent trailer of FIG. 4;

FIG. 6 is a front end view of the mobile tent trailer of FIG. 4;

FIG. 7 is a front end view of the mobile tent trailer with the side walls in the open position;

FIG. 8 is a rear end view of the mobile tent trailer with the side walls in the open position;

FIGS. 9A and B are fragmented side views of the mobile tent trailer with the side walls in the open position and the stairs in the retracted and deployed positions, respectively;

FIG. 10 is a top plan view of the mobile tent trailer in the open position;

FIGS. 11A and B are fragmented cross-sectional views along line 11-11 of FIG. 10 showing the floor spacer in the stored and extended positions, respectively;

FIG. 12A is a simplified top plan view of one of the side walls in the closed position showing the legs and braces in the stored position;

FIG. 12B is a side plan view of the side wall of FIG. 12A in the open position with the leg and braces extended;

FIG. 12C is a partial cross-sectional view of the side wall along line C-C of FIG. 12B showing the cross-trailer bracing for one of the legs;

FIG. 13 is a side view of the mobile tent trailer with the railings extended and the tent support posts assembled;

FIG. 14 is a rear end view of the mobile tent trailer of FIG. 13;

FIG. 15 is a simplified top plan view of the tent support structure;

FIG. 16 is a fragmented view of the extendable railing and the latching mechanism therein; and

FIG. 17 is a top plan view of the mobile tent trailer showing the layout of the subfloor within the frame and the storage compartments therein.

### DETAILED DESCRIPTION

The following description is merely exemplary in nature and is not intended to limit the present teachings, application, or uses.

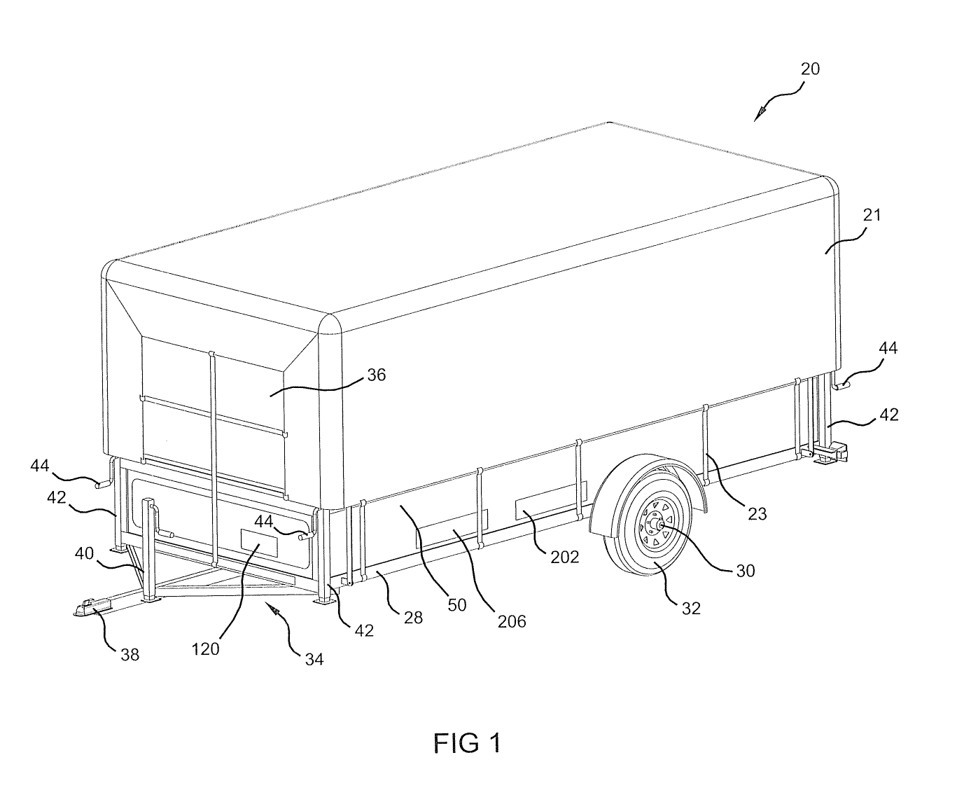

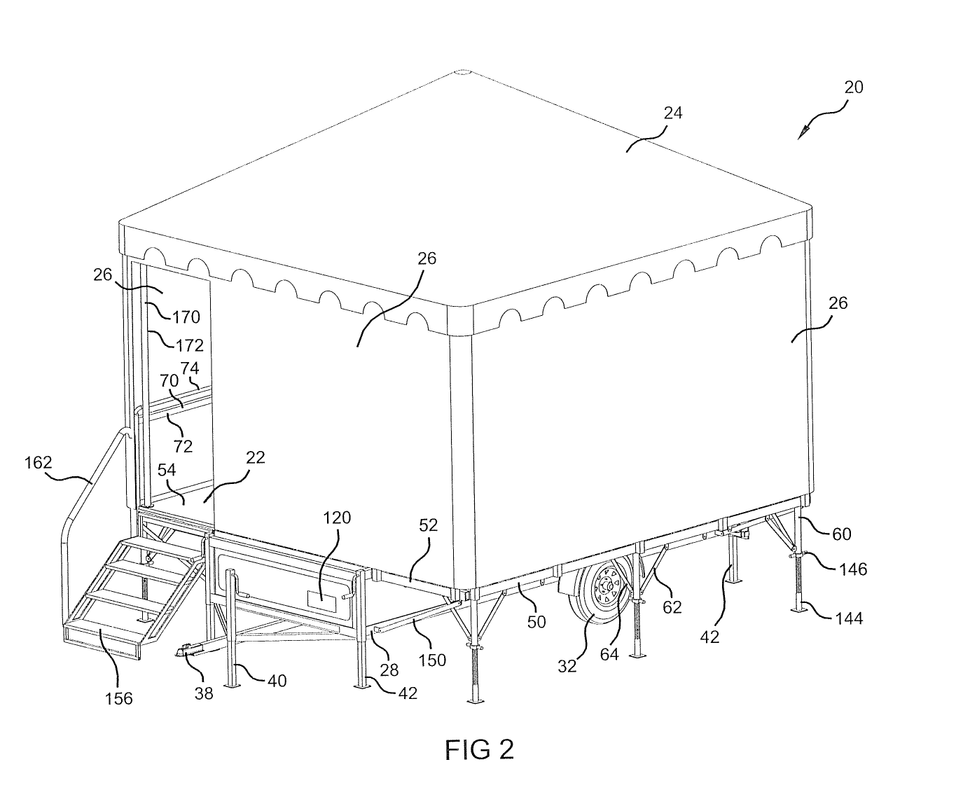

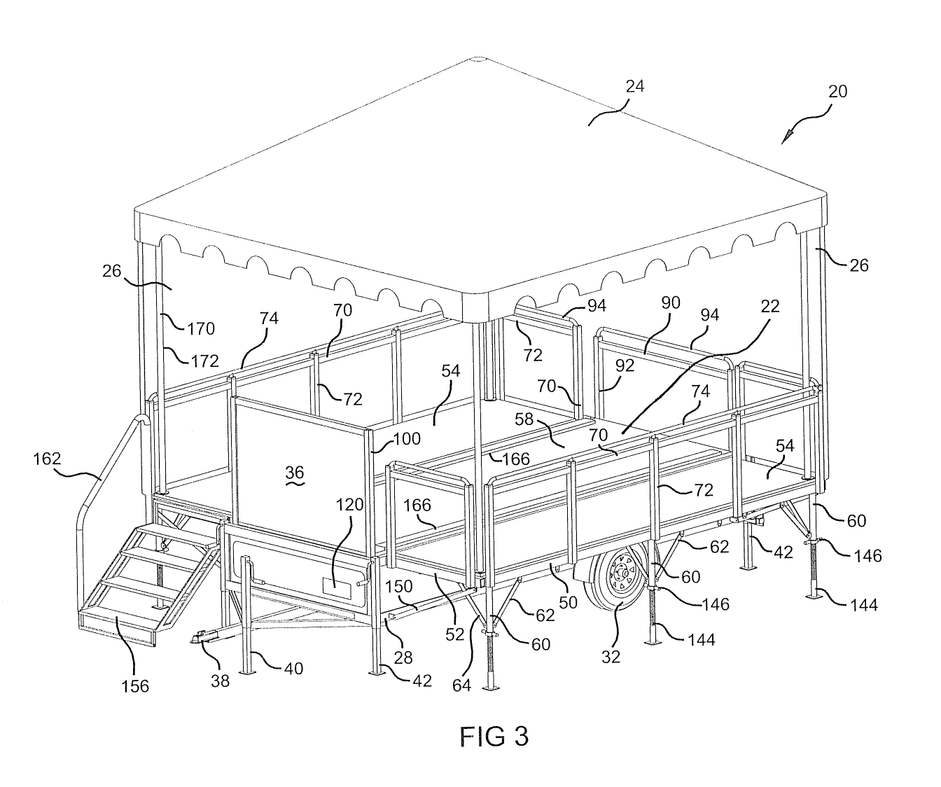

Referring to FIGS. 1-3, a mobile tent trailer 20 according to the present teachings is shown. Mobile tent trailer 20 can be configured in a closed or retracted position, as shown in FIG. 1, for travel along the roadways. In the closed position, a travel cover 21 can provide protection for mobile tent trailer 20. Travel cover 21 can be secured to mobile tent trailer 20 with elastic bands 23. Mobile tent trailer 20 can be extended or opened at a desired location, as shown in FIGS. 2 and 3, to provide an elevated platform 22 that can include a roof covering 24 and one or more side covers 26.

Mobile tent trailer 20 includes a central frame portion 28 that is supported by a transversely-extending axle 30 having a wheel 32 on each end. A front portion 34 of central frame 28 can extend longitudinally forward from a front wall 36 of mobile tent trailer 20. Front portion 34 can include a trailer hitch 38, such as a ball-receiving hitch. Axle 30, wheels 32, and trailer hitch 38 enable mobile tent trailer 20 to be pulled along the roadways by a vehicle. Front portion 34 of central frame 28 can include an extendible jacking leg 40 to adjust the fore-and-aft tilt of mobile tent trailer 20 to provide for a level elevated platform 22. Jacking leg 40 can include a wheel on the bottom thereof. Support legs 42 can be disposed at each corner of central frame 28 to provide support to mobile tent trailer 20 when in the open position. Support legs 42 can include a jack-screw mechanism with a handle 44 that enables support leg 42 to be vertically adjusted to engage the ground below mobile tent trailer 20 and provide stability to mobile tent trailer 20.

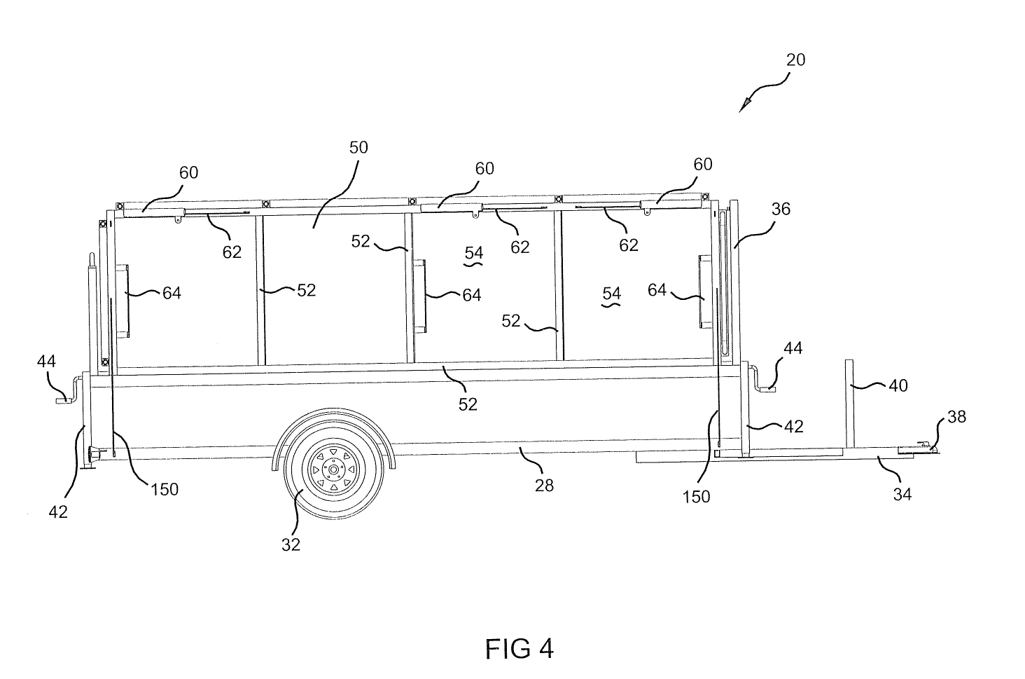

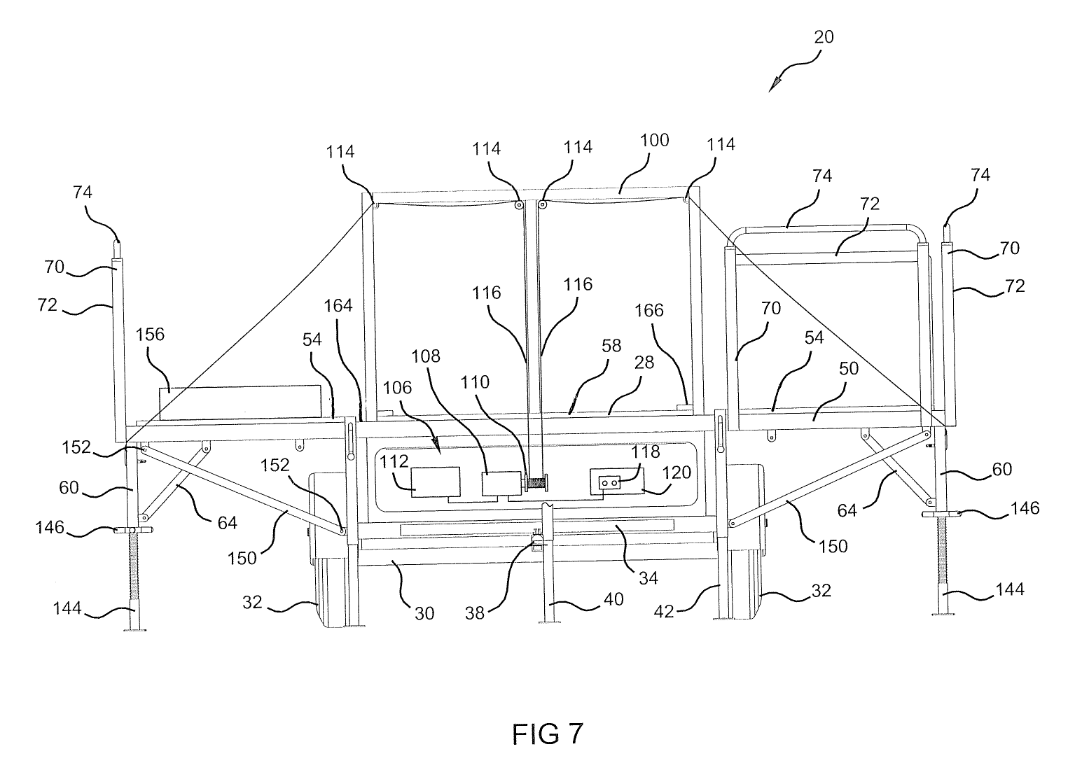

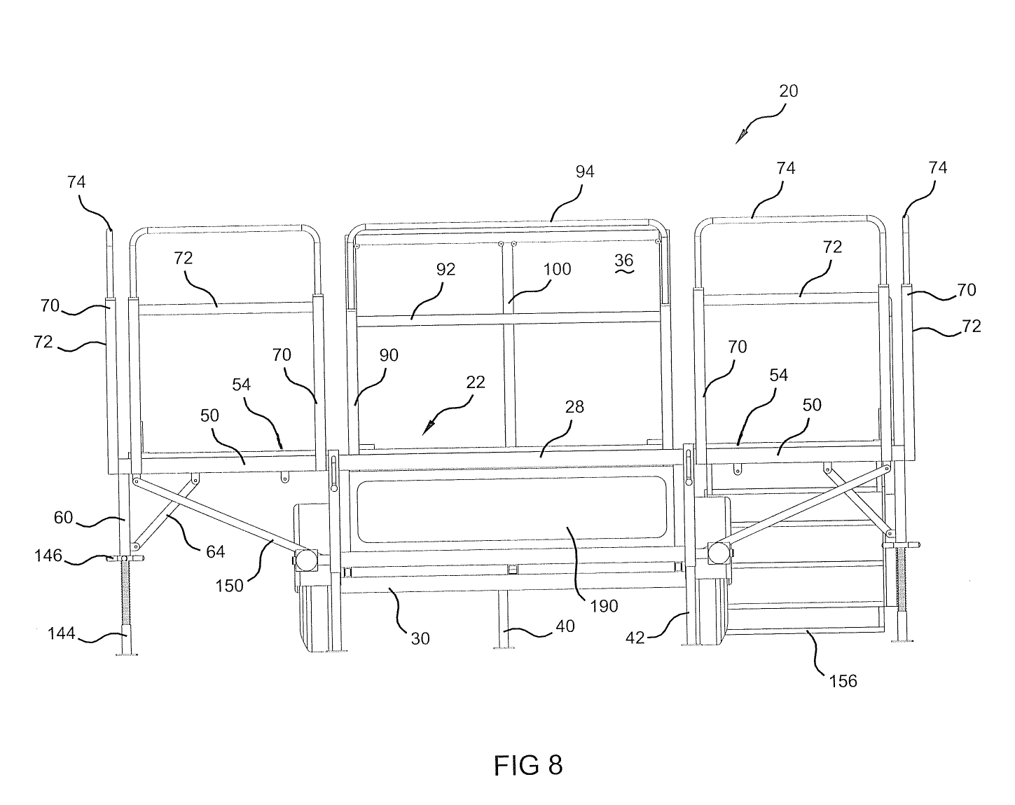

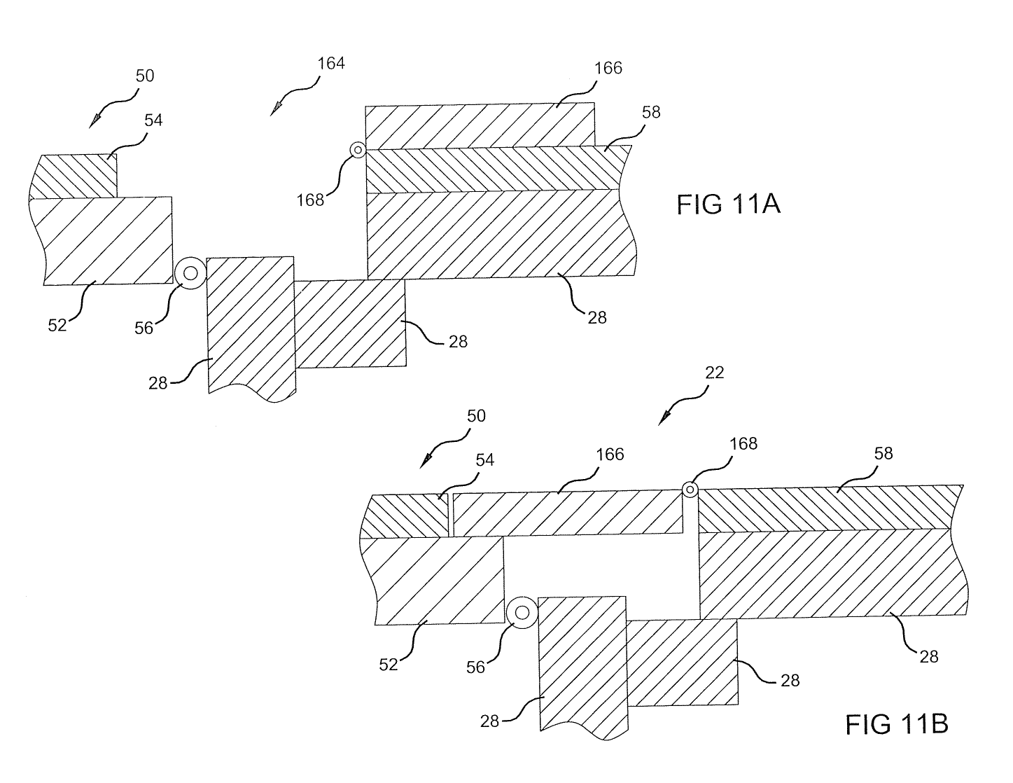

Referring now to FIGS. 4-8, mobile tent trailer 20 can include a pair of movable side walls 50 that can move between a substantially-vertical closed position, as shown in FIGS. 4-6, to a substantially-horizontal open position, as shown in FIGS. 7 and 8. Side walls 50 can each include a frame 52 with a floorboard 54 secured thereto. Frame 52 can be pivotally coupled to central frame 28 with a plurality of hinges 56 (FIG. 11). When side walls 50 are in the open position, as shown in FIGS. 7 and 8, floorboards 54 of side walls 50 can be substantially-coplanar with floorboard 58 on central frame 28 to thereby form a substantially planar elevated platform 22.

Each side wall 50 can include a plurality of legs 60 that can be extended therefrom to support side walls 50 when in the open position. Legs 60 can be pivotally coupled to frame 52. Each side wall 50 can include a fore-and-aft longitudinally extending brace 62 that can be pivotally coupled to frame 52. Each side wall 50 can also include a plurality of transversely-extending braces 64 that can be pivotally coupled to frame 52. Braces 62, 64 can pivot about frame 52 and can be secured to leg 60 to maintain leg 60 in the extended position, as described below.

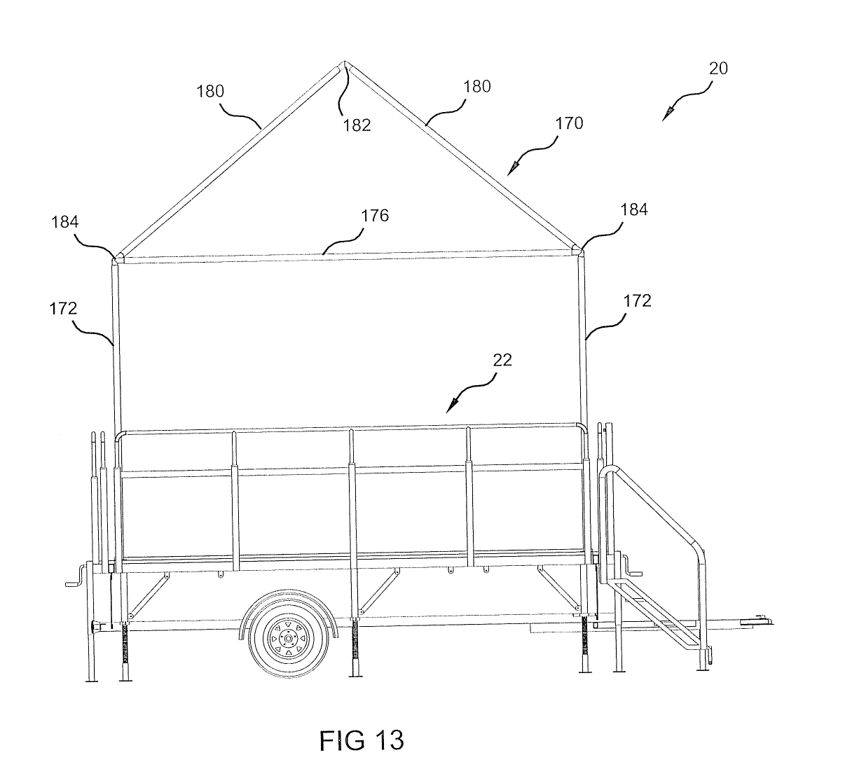

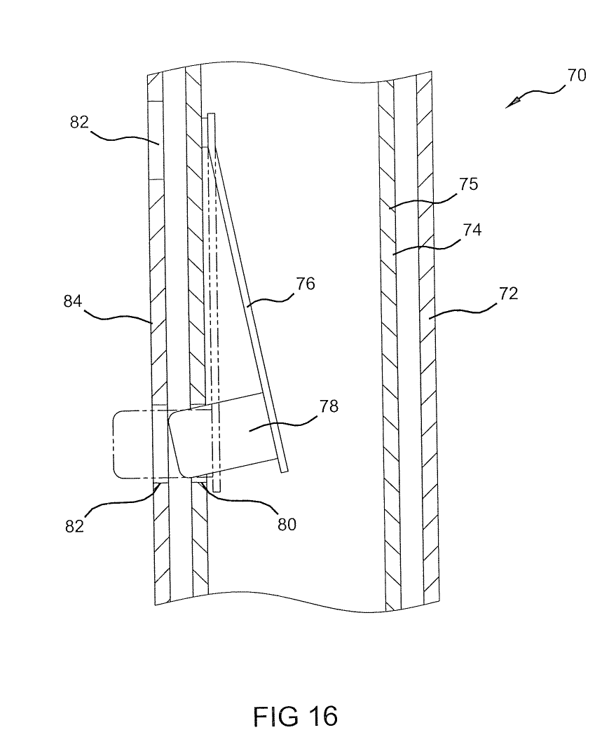

Each side wall 50 can include a handrail 70 that extends outwardly from frame 52. Handrail 70 moves with the pivotal movement of side walls 50 between the closed and open positions. Handrail 70 can include a lower fixed portion 72 and an extendible upper portion 74. The extendible portion 74 is typically in its retracted state, as shown in FIGS. 4-7, when side walls 50 are in the closed position or are first lowered into the open position. Extendible portion 74 can be extended upwardly from fixed portion 72 to provide a handrail of a larger height when side walls 50 are in the open position, as shown in FIGS. 8 and 13. Extendible portion 74 can be locked in the extended or retracted position. For example, as shown in FIG. 16, the vertically-extending legs 75 of extendible portion 74 can include an internal spring 76 connected to a snap button 78. Snap button 78 can extend through an opening 80 in the vertical leg 75 of extendible portion 74 and through a complementary opening 82 in a vertical leg 84 of fixed portion 72. Spring 76 can bias snap button 78 outwardly from leg 75 to engage with the complementary opening 82 in leg 84 of fixed portion 72. Leg 84 of fixed portion 72 can include a plurality of vertically spaced apart openings 82 to allow extendible portion 74 to be fixed at a variety of heights. Thus, when setting up mobile tent trailer 20, extendible portion 74 of handrail 70 can be extended to a desired height by pushing snap button 78 inwardly and pulling upwardly on extendible portion 74. When snap button 78 engages with an opening 82, extendible portion 74 of handrail 70 can be locked in place.

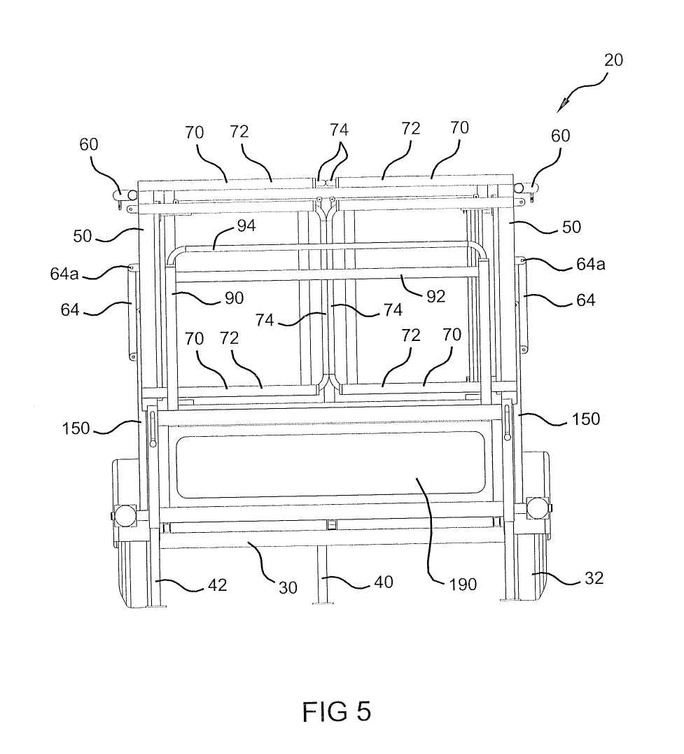

A rear handrail 90 can extend upwardly from the rear portion of central frame 28, as shown in FIGS. 5 and 8. Rear handrail 90 includes a lower fixed portion 92 and an extendible upper portion 94. Handrail 90 is substantially the same as handrails 70 along side walls 50 and the operation to move extendible portion 94 between the retracted and extended positions is the same. Accordingly, operation of extendible portion 94 is not discussed further.

Front wall 36 extends upwardly from the front of central frame 28. Front wall 36 can be secured to a fixed frame 100 that can be fixed to the front portion of central frame 28. Front wall 36 can have a vertical height that is essentially the same as that of handrail 70 when in an extended position.

A drive system 106 can be used to move side walls 50 between the closed and open positions. Drive system 106 can be disposed in a front portion of mobile tent trailer 20. Drive system 106 can include a winch 108 which can drive rotation of a drum 110. A battery 112 can be used as a power source for winch 108. A plurality of pulleys 114 can be coupled to frame 100. Two separate cables 116 can each be coupled to one of side walls 50 and to drum 110. Cables 116 can extend along pulleys 114 between side walls 50 and drum 110. Rotation of drum 110 can shorten/lengthen the portion of the cables 116 that extends from drum 110 thereby pivoting side walls 50 about hinges 56 between the closed and open positions. Cables 116 can be detached from side walls 50, once side walls 50 are in the open position, to allow cables 116 to be stowed in a convenient out-of-the-way location. A remote controller 118 can be used to command winch 108 to rotate drum 110 in a desired direction to move side walls 50 between the open and closed positions.

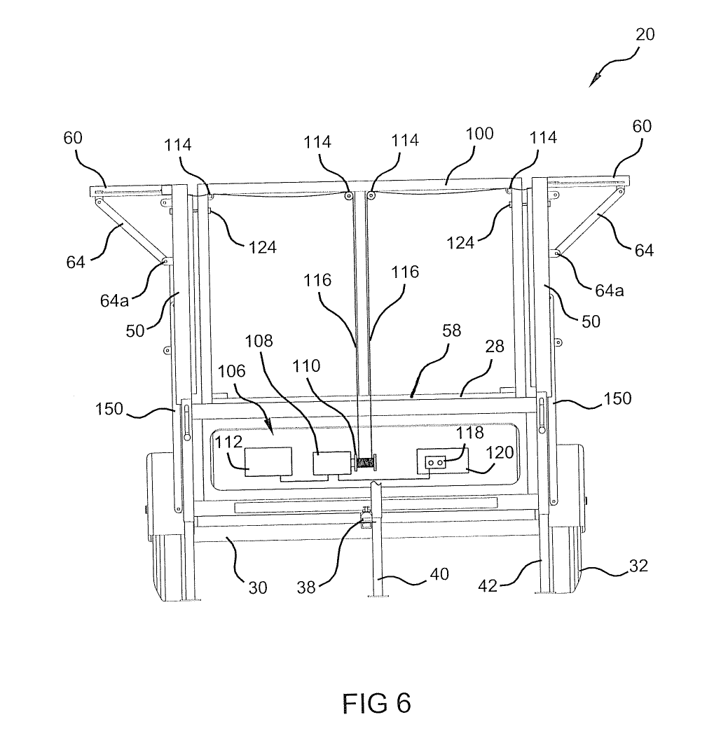

Winch 108, drum 110, battery 112, and controller 118 can be stored within central frame 28 below floorboard 58, as shown in FIGS. 6 and 7. An access door or panel 120 can be disposed on the front portion of central frame 28 to allow access to controller 118 therein. Additionally, a charging connection can be disposed behind access panel 120 that enables battery 112 to be remotely charged. Access to winch 108, drum 110, and battery 112 can be achieved by removing a portion of floorboard 58 from central frame 28. If desired, additional access doors (not shown) can be disposed on the front of central frame 28 to allow access to the components therebehind. A pair of locking pins 124 can secure side walls 50 in the closed position. Each locking pin 124 can extend through frame 100 and frame 52 of each side wall 50 to lock side walls 50 in the closed position. Locking pins 124 can be removed to allow side walls 50 to move between the closed and open positions, as described above.

When it is desired to open mobile tent trailer 20, travel cover 21 is removed by unhooking the elastic bands 23 that hold travel cover 21 to mobile tent trailer 20. Jacking leg 40 is extended to disengage trailer hitch 38 from the vehicle that was used to position mobile tent trailer 20 in its desired position. Jacking leg 40 is adjusted so that mobile tent trailer 20 is generally level. Support legs 42 can be lowered to engage with the ground on which mobile tent trailer 20 is disposed. Support legs 42 are extended by rotation of handles 44. Depending upon the strength of support legs 42, support legs 42 may be capable of providing transverse leveling of mobile tent trailer 20. With support legs 42 extended and engaged with the ground, legs 60 on each side wall 50 can be deployed.

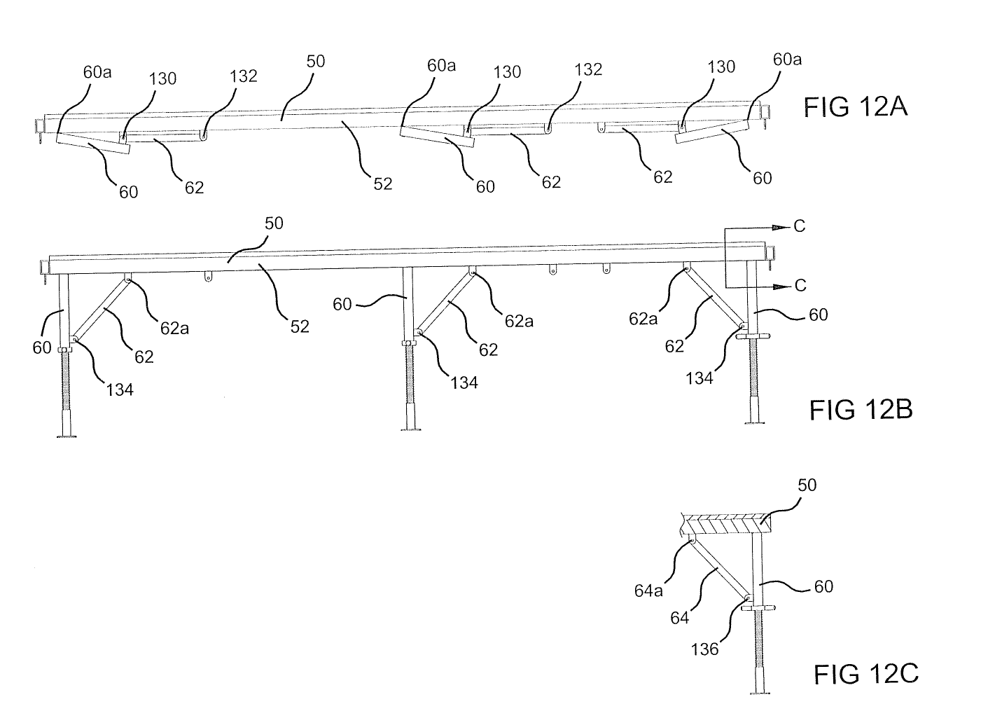

Referring to FIGS. 12A-C, the deployment of legs 60 is shown. Each leg 60 can be held in its stored position, as shown in FIG. 12A, with a fastener 130. When fasteners 130 are removed, each leg 60 can be pivoted about a pivot 60a that couples leg 60 to frame 52 of side wall 50. Longitudinal braces 62 can also be secured in the stored position by a fastener 132. Removal of fasteners 132 allows longitudinal braces 62 to pivot about the pivots 62a toward the end of legs 60, as shown in FIG. 12B. The end of longitudinal brace 62 can be secured to leg 60 with a fastener 134. Longitudinal braces 62 can thereby restrain longitudinal movement of legs 60 about pivots 60a. Similarly, transverse braces 64, as shown in FIGS. 4 and 12C, can be secured in the stored position by fasteners 136. Fasteners 136 can be removed and transverse braces 64 rotated about pivot 64a to be adjacent extended legs 60. The free end of transverse braces 64 can be secured to extended legs 60 to provide transverse support for leg 60 utilizing the same fastener 136. With legs 60 in the extended position and both longitudinal and transverse braces 62, 64 secured thereto, mobile tent trailer 20 is ready to have side walls 50 moved from the closed position to the open position.

Locking pins 124 can be removed. When locking pins 124 are removed, controller 118 can be operated to cause winch 108 to drive rotation of drum 110 to extend cables 116 and begin lowering side walls 50. Controller 118 is operated to continue to cause side walls 50 to move toward their open position. Prior to side walls 50 being in the fully opened position, threaded support feet 144, with an adjustable threaded collar 146 thereon, are inserted into the free end of each leg 60. Adjustable collars 146 are rotated about support feet 144 to cause support feet 144 to extend outwardly beyond legs 60 the approximate distance required to have floorboards 54 of side walls 50 be substantially-coplanar with floorboard 58 of central frame 28. Controller 118 can be operated to further command winch 108 to lower side walls 50 until side walls 50 are being supported by support feet 144 and legs 60. Adjustable collars 146 can then be adjusted to the proper position relative to support feet 144 to cause floorboards 54 of side walls 50 to be substantially-coplanar with floorboard 58 of central frame 28. Winch 108 can be operated to facilitate the aligning of floorboards 54 and 58. Cables 116 can then be disengaged from frames 52 of side walls 50. If needed, controller 118 can cause winch 108 to cause further slack in cables 116 to facilitate the disengagement of cables 116 from side walls 50. With side walls 50 in their substantially-coplanar position, floor support braces 150, as shown in FIG. 7, can be secured to each corner of central frame 28 and each corner of side walls 50 with fasteners 152 to provide additional bracing and support for side walls 50. Floor support braces 150 can also help facilitate the coplanar alignment of floorboards 54 of side walls 50 with floorboards 58 of central frame 28.

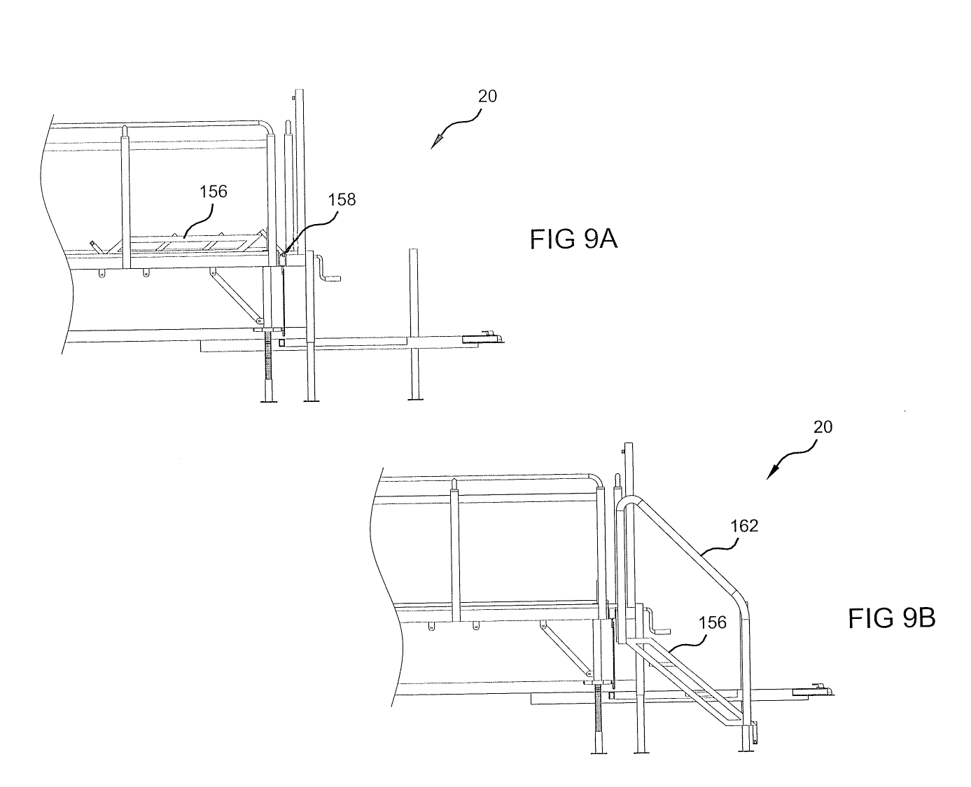

Referring now to FIGS. 9A and B, stairs 156 on one of side walls 50 can be moved from a stowed position, as shown in FIG. 9A, to a deployed position, as shown in 9B. One end of stairs 156 is pivotally coupled to a front edge of frame 52 of side wall 50 by a hinge 158. The free end of stairs 156 is secured in the stowed position to floorboard 54 of side wall 50 with a fastener or lock pin (not shown). The lock pin can be removed and stairs 156 rotated about hinge 158 to the deployed position, as shown in FIG. 9B. A pair of handrails 162 can be attached to the deployed stairs 156 by inserting the ends of handrails 162 in receptacles along each side of stairs 156.

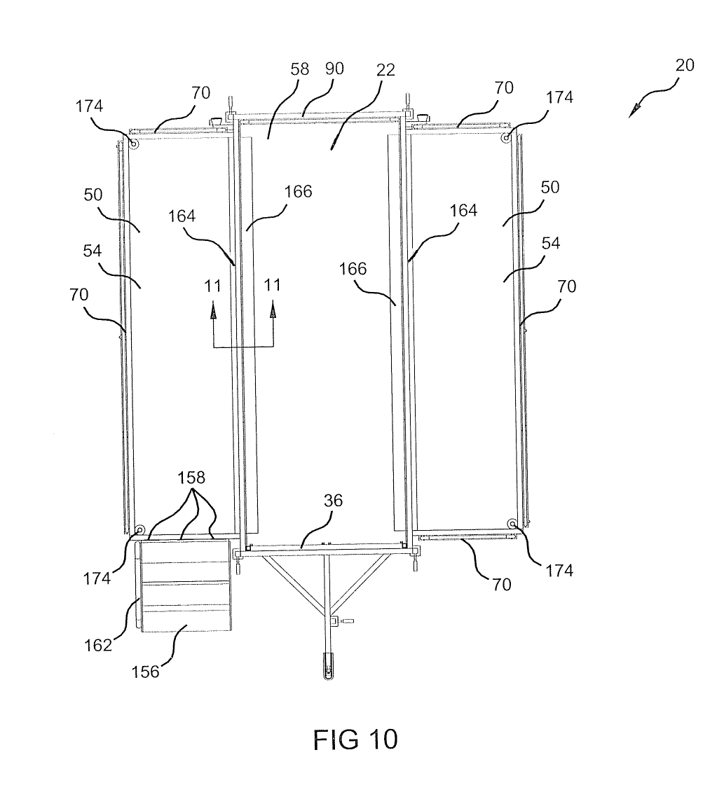

As shown in FIG. 10, the movement of side walls 50 from the closed position to the open position results in a gap 164 to exist between floorboards 54 and 58. A pair of floor spacers 166 can be utilized to cover gap 164 and provide a flush surface between floorboards 58 and floorboards 54. As shown in FIGS. 10 and 11, floor spacers 166 can be pivotally connected to floorboards 58 with a plurality of hinges 168. Hinges 168 allow floor spacers 166 to be pivoted from a stored position, as shown in FIG. 11A, to an operable position, as shown in FIG. 11B. When floor spacers 166 are in the operable position, floor spacers 166, floorboards 58, and floorboards 54 provide a substantially-coplanar surface for elevated platform 22. Extendible portions 74, 94 of handrails 70, 90 can be moved from the retracted position to the elevated or operable position by operation of the associated snap button.

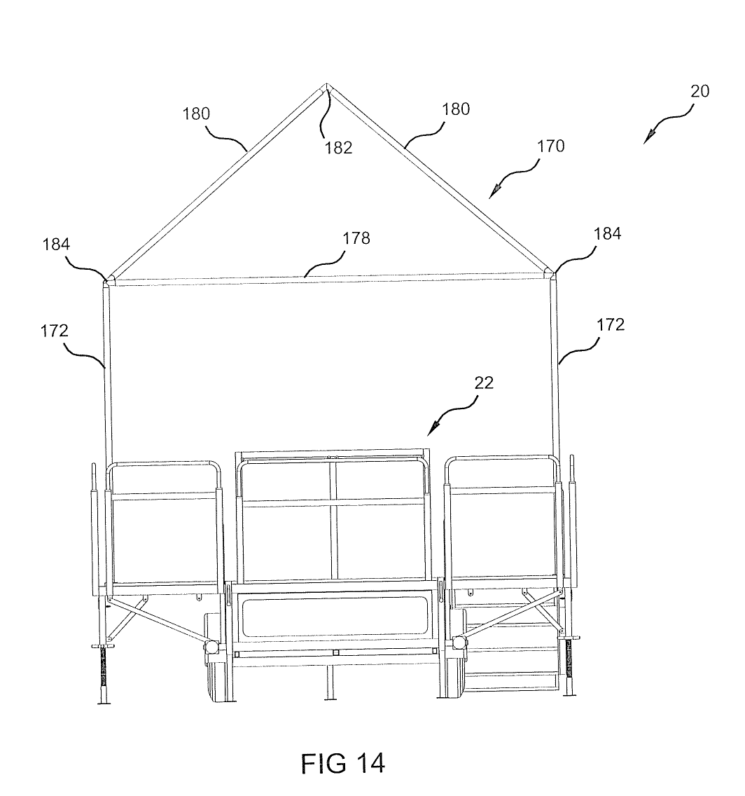

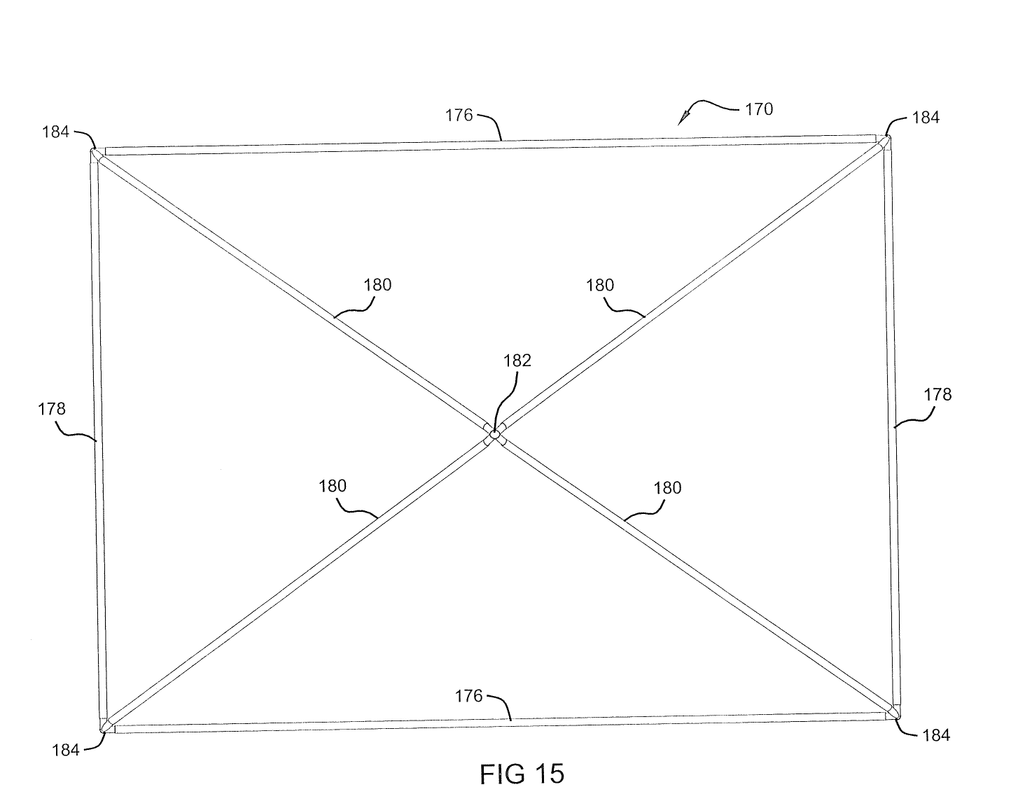

With side walls 50 deployed, along with stairs 156 and handrails 70, 90, a tent support structure 170 can then be secured to mobile tent trailer 20. Tent support structure 170, as shown in FIGS. 2, 3, 10, and 13-15, can include a plurality of vertical poles 172 that can form the vertically-extending base for tent support structure 170. Vertical poles 172 can be disposed in complementary round pipe supports 174 located on the outer corners of side walls 50. Vertical poles 172 can be secured in pipe supports 174 with a lock pin. The top portion of tent support structure 170 can include a pair of longitudinal poles 176, a pair of transverse poles 178, and four roof poles 180. A peak connector 182 has four arms that each engage with an end of roof poles 180. Lock pins can be used to hold roof poles 180 to peak connector 182. Four corner connectors 184 each have four arms. Arms of corner connectors 184 can be disposed in an end of a vertical pole 172, a longitudinal pole 176, a transverse pole 178, and the free end of a roof pole 180. Lock pins can be used to secure corner connectors 184 to poles 172, 176, 178, 180. With all of the poles 172, 176, 178, 180 secured in position with pipe supports 174, peak connector 182, and corner connectors 184, tent support structure 170 is formed and secured in place, as shown in FIGS. 13 and 14.

Roof covering 24 can be draped over the top of tent support structure 170 and secured to one or more of the poles therein to hold roof covering 24 in position. As desired, one or more side coverings 26 can be secured to the appropriate vertical poles 172, longitudinal poles 176, and transverse poles 178 to hold the side coverings 26 in their desired position. The number of side coverings 26 can vary from zero to four or more. One of the side coverings 26 can have a cutout that is associated with the location of stairs 156 to form an entryway into the interior of mobile tent trailer 20.

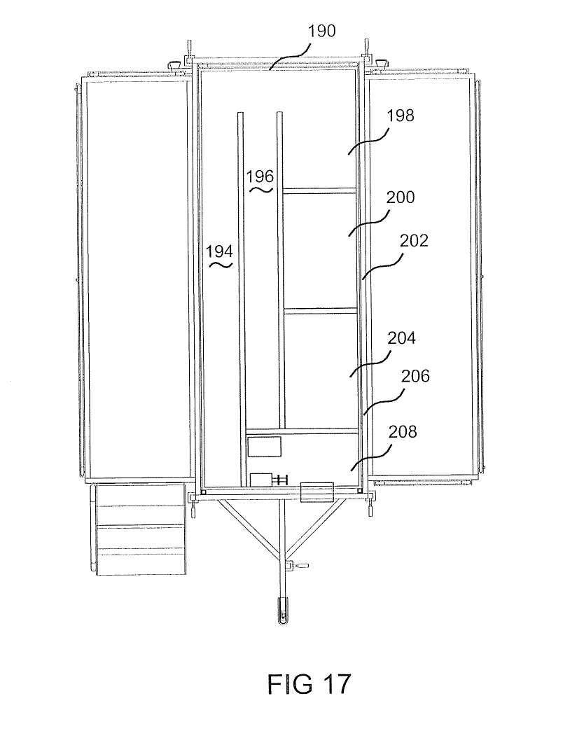

Referring now to FIG. 17, details of the storage capabilities within central frame 28 are shown. Central frame 28 can include a variety of storage compartments beneath floorboards 58. These storage compartments can be accessed by a rear access door 190 and one or more side access doors. Central frame 28 can have storage compartments of various configurations, as desired. For example, as shown, central frame 28 can be divided to provide a first stowage area 194 that can be used to store the long poles of tent support structure 170. A second stowage area 196 can be slightly shorter than first stowage area 194 and can be used to store the shorter poles of tent support structure 170. A third stowage area 198 can be used to store side covers 26 and roof covering 24. First, second, and third stowage areas 194, 196, 198 can all be accessed through rear access door 190. A fourth stowage area 200 can be disposed in front of third stowage area 198 and can be accessed from a side access door 202. Fourth stowage area 200 can be used to stow other equipment, such as spare tires, jacks, and miscellaneous items. A fifth stowage area 204 can be disposed in front of fourth stowage area 200 and accessed by another side access door 206. Additionally, central frame 28 can include a front stowage area 208 that can be used to contain various components of drive system 106. Thus, central frame 28 can be configured to provide various stowage areas below floorboards 58 to house the various components of mobile tent trailer 20.

Mobile tent trailer 20 thereby provides a substantially-coplanar and level elevated platform 22 for use at a remote location. Mobile tent trailer 20 can be used as a television studio to broadcast/record newscasters or talent at an on-location site. If desired, one or more screens can be hung from tent support structure 170 to provide a desired backing or background during the filming operation. Additionally, mobile tent trailer 20 can be supplied with a heater and/or air conditioning unit to provide a climate-controlled environment within mobile tent trailer 20. Additionally, it should be appreciated that mobile tent trailer 20 can be used for a variety of other purposes wherein a level elevated platform is useful. The ability to pull mobile tent trailer 20 along the roadways facilitates the use of mobile tent trailer 20 in a variety of locations. It should be appreciated that mobile tent trailer 20 can also be pulled along non-roadway surfaces to provide a level elevated platform at a desired location.

1. An expandable mobile tent trailer comprising:
a frame;
at least two wheels coupled to said frame and operable to allow said frame to be pulled along a roadway;
a first floor surface on said frame;
at least one side wall moveably coupled to said frame, said at least one side wall being moveable relative to said frame between a first position wherein the mobile tent trailer can be hauled along a roadway and a second position wherein said at least one side wall forms a second floor surface;
a handrail secured to said at least one side wall and moving with said at least one side wall between said first and second positions;
a movable stairway pivotally coupled to said at least one side wall and moving with movement of said at least one side wall between said first and second positions, said stairway being pivotally moveable from a stowed position on said at least one side wall to an operable position extending from the ground to said second floor when said at least one side wall is in said second position,
wherein said first position corresponds to said at least one side wall being substantially vertically oriented and said second position corresponds to said at least one side wall being substantially horizontally oriented, and said first and second floor surfaces form a platform upon which people may engage in activities when said at least one side wall is in said second position.

2. (canceled)

3. The expandable mobile tent trailer of claim 1, wherein said at least one side wall is one of two side walls pivotally coupled to opposing sides of said frame and each movable between said first and second positions, said side walls forming a pair of second floor surfaces adjacent opposing sides of said first floor surface when in said second position and said first and second floor surfaces forming a substantially planar platform upon which people may engage in activities when said two side walls are in said second position.

4. The expandable mobile tent trailer of claim 3, further comprising a drive system operable to drive movement of said side walls between said first and second positions.

5. The expandable mobile tent trailer of claim 4, wherein said drive system includes:
a winch;
a rotatable drum coupled to and driven by said winch;
a plurality of pulleys; and
a pair of cables each coupled to said drum and one of said side walls and engaged with at least one of said pulleys.

6. The expandable mobile tent trailer of claim 1, wherein said hand rail includes a first portion fixedly secured to said at least one side wall and a second portion moveably coupled to said first portion, said second portion being movable between a retracted position corresponding to a first height of said handrail and an extended position corresponding to a second height of said handrail greater than said first height.

7. The expandable mobile tent trailer of claim 6, wherein said second portion is telescopically coupled to said first portion and moves telescopically between said retracted position and said extended position.

8. The expandable mobile tent trailer of claim 1, wherein said first and second floor surfaces are substantially co-planar when said at least one side wall is in said second position.

9. An expandable mobile tent trailer comprising:
a frame;
at least two wheels coupled to said frame and operable to allow said frame to be pulled along a roadway;
a first floor surface on said frame;
at least one side wall moveably coupled to said frame, said at least one side wall being moveable relative to said frame between a first generally vertical position wherein the mobile tent trailer can be hauled along a roadway and a second generally horizontal position wherein said at least one side wall forms a second floor surface. and said second floor surface in conjunction with said first floor surface form a platform upon which people may engage in activities when said at least one side wall is in said second position:
a handrail secured to said at least one side wall and moving with said at least one side wall between said first and second positions;
a flexible roof cover;
at least one flexible side cover extending from said roof cover to said at least one side wall when in said second position;
a plurality of removable framing structures operable to be secured to different portions of said at least one side wall when in said second position and extend generally vertically from said at least one side wall, and to provide support for said flexible roof cover and said at least one flexible side cover to form a roof and at least one wall for said platform.

10. (canceled)

11. The expandable mobile tent trailer of claim 1, wherein said at least one side wall is pivotally coupled to said frame and pivots between said first and second positions.

12. An expandable mobile tent trailer comprising:
a frame;
at least two wheels coupled to said frame and operable to allow said frame to be pulled along a roadway;
a first floor surface on said frame;
at least one side wall moveably coupled to said frame, said at least one side wall being moveable relative to said frame between a first substantially vertical position wherein the mobile tent trailer can be hauled along a roadway and a second substantially horizontal position wherein said at least one side wall forms a second floor surface;
at least one floor spacer operable to selectively cover at least a portion of a gap between said first and second floor surfaces when said at least one side wall is in said second position; and
at least one handrail attached to said at least one side wall and moving with movement of said at least one side wall between said first and second positions,
wherein said first and second floor surfaces and said at least one spacer form a substantially planar platform upon which people may engage in activities when said at least one side wall is in said second position.

13. (canceled)

14. The expandable mobile tent trailer of claim 12, wherein said at least one side wall is one of two side walls pivotally coupled to opposing sides of said frame and each movable between said first and second positions, said side walls form a pair of second floor surfaces adjacent opposing sides of said first floor surface when in said second position, said first and second floor surfaces and said at least one spacer form a substantially planar platform upon which people may engage in activities when said two side walls are in said second position, and said at least one handrail is one of a plurality of handrails attached to said side walls.

15. The expandable mobile tent trailer of claim 14, further comprising a drive system operable to drive movement of said side walls between said first and second positions, said drive system including:
a winch;
a rotatable drum coupled to and driven by said winch;
a plurality of pulleys; and
a pair of cables each coupled to said drum and one of said side walls and engaged with at least one of said pulleys.

16. (canceled)

17. The expandable mobile tent trailer of claim 12, further comprising a removable framing structure operable to be secured to said at least one side wall and to provide support for a flexible roof cover and at least one flexible side cover to form a roof and at least one wall for said platform.

18. The expandable mobile tent trailer of claim 12, wherein said at least one side wall is pivotally coupled to said frame and pivots between said first and second positions.

19-20. (canceled)

21. The expandable mobile tent trailer of claim 1, further comprising at least one handrail selectively attachable to a side of said movable stairway when in said operable position.

22. The expandable mobile tent trailer of claim 1, wherein said movable stairway is flush against said at least one side wall when in said stowed position.

23. The expandable mobile tent trailer of claim 9, further comprising a plurality of removable support members extending generally horizontally between said framing structures and operable to support said roof cover and said at least one side cover.

24. The expandable mobile tent trailer of claim 12, wherein said at least one handrail is a telescopic handrail having a first stationary portion attached to said at least one side wall and a second portion telescopically coupled to said first portion, said second portion being movable between a retracted position corresponding to a first height of said at least one handrail and an extended position corresponding to a second height of said at least one handrail greater than said first height.

25. The expandable mobile tent trailer of claim 12, wherein said at least one floor spacer is pivotally coupled to at least one of said first and second floor surfaces.

26. The expandable mobile tent trailer of claim 25, wherein said at least one floor spacer is pivotally coupled to said first floor surface.
